(19) United States
(12) Patent Application Publication
(10) Pub. No.: US 2024/0323497 A1
(43) Pub. Date: Sep. 26, 2024

(54) SYSTEMS AND METHODS FOR ENABLING AN ENHANCED EXTENDED REALITY EXPERIENCE

(71) Applicant: Adeia Guides Inc., San Jose, CA (US)

(72) Inventor: Charles Dasher, Lawrenceville, GA (US)

(21) Appl. No.: 18/123,625

(22) Filed: Mar. 20, 2023

(51) Int. Cl. H04N 21/81; G06T 11/00; H04N 21/472; H04N 21/8547

(52) U.S. Cl. CPC H04N 21/8133; G06T 11/00; H04N 21/47217; H04N 21/8547

(57) ABSTRACT

Systems and methods are provided for enabling an enhanced extended reality experience. A virtual space is mapped to a physical space at an extended reality device, and pre-generated extended reality content, for display with a content item, is received at the extended reality device. It is identified that the content item has started playback at a display, and the content item and the extended reality content are generated for concurrent output at the extended reality device.

### BACKGROUND

One or more disclosed embodiments are directed towards systems and methods for enabling an enhanced extended reality (XR) experience. In particular, systems and methods are provided herein that enable the concurrent output of a content item and pre-generated extended reality content. Some embodiments or aspects relate to additional or alternative features, functionalities, or fields.

### SUMMARY

With the emergence of extended reality and the increasing importance of how people use extended reality to interact in their daily lives, people and companies will have an increasing need to augment existing goods and services with extended augmented reality environments. Extended reality or XR is an umbrella term referring to virtual reality (VR), mixed or merged reality (MR), augmented reality (AR), or some combination thereof. People are used to receiving content items, such as movies and episodes of a series, via streaming, or over-the-top (OTT), content platforms. Such platforms already offer users content items in a variety of different formats, for example standard definition, high definition and ultra-high definition. Users used to extended reality experiences may wish to interact with content items, or augment content items, in a manner that they have become accustomed to.

To overcome these problems, systems and methods are provided herein that enable an enhanced extended reality experience.

Systems and methods are described herein for enabling an enhanced extended reality experience. In accordance with some aspects of the disclosure, a method is provided. The method includes mapping a virtual space to a physical space at an extended reality device and receiving pre-generated extended reality content for display with a content item at the extended reality device. It is identified that the content item has started playback at a display, and the content item and the extended reality content are generated for concurrent output at the extended reality device.

In an example system, a virtual space is mapped to a physical space at an extended reality device, such as an augmented reality headset. In this example, the augmented reality headset spatially maps an extended reality environment, such as an augmented reality environment, based on the physical environment. Pre-generated extended reality content is received at the extended reality device. The pre-generated extended reality content may comprise one or more objects based on, for example, a corresponding content item. This may comprise one or more characters from the content item and/or one or more objects for extending a scene from the content item. The objects, or items, are pre-generated, such that the augmented reality device may generate them for output based on the received data. In this example, the pre-generated extended reality content is received from a server via a network, such as the internet. It is identified whether content item playback has started. Playback of a content item may be at a physical computing device, such as a smart television and/or via the extended reality device itself. This identification may be via, for example, data transferred between an application running on a smart television and an application running on the augmented reality headset. The content item and the extended reality content are generated for concurrent output at the extended reality device and/or other computing device, such as a smart television.

A time stamp of the content item may be identified, and a corresponding time stamp of the extended reality content may be identified. Generating the extended reality content for output at the extended reality device may further comprise generating the extended reality content for output at the corresponding time stamp.

The display may be a physical display (e.g., distinct and separate from the display of the extended reality device). The physical display may be identified at the extended reality device, and the content item may be played back at the physical display. The display may be a virtual display, a virtual display for outputting the content item may be generated at the extended reality device, and the content item may be played back at the virtual display.

The pre-generated extended reality content may further comprise metadata indicating a relative location, movement data and/or timing data for an extended reality object, animation and/or scene.

A request to access a preview of the pre-generated extended reality content may be received at a physical computing device, and a two-dimensional (2D) representation of at least a portion of the virtual reality content may be generated for output at the physical computing device. Input associated with navigating the preview may be received at the physical computing device. An updated view of the virtual reality content based on the input may be generated for output at the physical computing device.

A user input to pause the content item may be received, and playback of the content item may be paused. A pre-generated virtual reality object may be generated for display at the extended reality device while the content item is paused. A virtual assistant may be integrated with the virtual reality object, and a query may be received via the integrated virtual assistant. A response to the query may be generated, and the response to the query may be concurrently output and animated based on the response to the query.

A volume around the display may be identified in the virtual space, and a path of one or more extended reality objects may be identified in the extended reality content. For each identified path, it may be determined whether the path will intersect with the volume, and for each path that intersects with the volume, the path may be amended so that it does not intersect with the volume.

A time stamp of the content item may be identified, and a corresponding time stamp of the extended reality content may be identified. Pre-generated extended reality content, for display with the content item, may be received at a second extended reality device, and the extended reality content may be generated for output at the second extended reality device at the corresponding time stamp. A user interaction with an extended reality object may be identified at the first extended reality device, and, based on the user interaction, the extended reality object may be generated for output at the first and second extended reality devices.

A content item guidance application may be generated for output. The content item guidance application may comprise a selectable asset region corresponding to a content item, and an icon, associated with the asset region, where the icon indicates that extended reality content is available for the content item.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for enabling an enhanced extended reality experience, in accordance with some embodiments of the disclosure;

FIG. 2 shows another example environment for enabling an enhanced extended reality experience, in accordance with some embodiments of the disclosure;

FIG. 3 shows another example environment for enabling an enhanced extended reality experience, in accordance with some embodiments of the disclosure;

FIG. 4 shows an example environment for enabling a preview of an enhanced extended reality experience, in accordance with some embodiments of the disclosure;

FIG. 5 shows an example environment for enabling an extended reality avatar, in accordance with some embodiments of the disclosure;

FIG. 6 shows an example environment for enabling a “keep-out” area in an reality experience, in accordance with some embodiments of the disclosure;

FIG. 7 shows a block diagram representing components of a computing device and dataflow therebetween for enabling an enhanced extended reality experience, in accordance with some embodiments of the disclosure;

FIG. 8 shows a flowchart of illustrative steps involved in enabling an enhanced extended reality experience, in accordance with some embodiments of the disclosure;

FIG. 9 shows a flowchart of illustrative steps involved in enabling extended reality enabled content to be previewed within a guide or media application, in accordance with some embodiments of the disclosure;

FIG. 10 shows a flowchart of illustrative steps involved in enabling a content-based virtual “theater” environment and changing the virtual reality environment to a virtual “theater,” in accordance with some embodiments of the disclosure;

FIG. 11 shows a flowchart of illustrative steps involved in enabling the playback of media content in a synchronized manner, in accordance with some embodiments of the disclosure;

FIG. 12 shows a flowchart of illustrative steps involved in enabling an interactive extended reality experience, in accordance with some embodiments of the disclosure;

FIG. 13 shows a flowchart of illustrative steps involved in enabling the generation of extended reality content for display in a spatially mapped room, in accordance with some embodiments of the disclosure; and

FIG. 14 shows a flowchart of illustrative steps involved in enabling interactive extended reality content to be generated for display in response to a pause command, in accordance with some embodiments of the disclosure.

### DETAILED DESCRIPTION

An extended reality device includes any computing device that enables the physical world to be augmented with one or more virtual objects and/or enables physical and virtual objects to interact with one another. An extended reality device may comprise a headset that is worn by a user and that enables virtual elements, or objects, to be superimposed, or projected, onto the physical world. In one example, the extended reality device may comprise a transparent, or substantially transparent, lens onto which virtual elements are projected, or displayed. In another example, an extended reality device may comprise an application running on a computing device comprising a camera, such as a tablet or smartphone. The application may display output from the camera and may superimpose, or draw, virtual elements onto the output from the camera. Extended reality devices include augmented reality headsets and mixed reality devices. Virtual reality devices that enable physical objects to passthrough into a virtual world are also contemplated.

In order to map a virtual space to a physical space, metadata describing scene information may be embedded in an encoded media file, for example, an MPEG file, AVI file, and/or an adaptive streaming segment. In another example, the metadata may be available via a resource locator, such as a uniform resource locator (URL), which may be indicated via a manifest file. For example, a URL may be utilized if an extended reality device is generating augmented enhancements for output with a content item being generated for output at a second computing device. Additionally, spatial mapping may take place via the scanning of any physical space, such as a room, to determine the shape, size, and other aspects relating to the physical space. Three-dimensional (3D) rendered objects may be generated for display within the mapped virtual space, or environment. These objects may be projected into a physical space as an augmented reality projection when using augmented reality glasses.

Generating for output includes displaying data and/or objects on a display integral to an extended reality device, generating data and/or objects for display on a display connected to an extended reality device, generating audio for output at one or more speakers integral to an extended reality device and/or generating audio for output at one or more speakers connected to an extended reality device.

Pre-generated extended reality content includes one or more objects based on, for example, a corresponding content item. This may comprise one or more characters from the content item and/or one or more objects for extending a scene from the content item. The objects, or items, are pre-generated, such that the augmented reality device may generate them for output based on the received data, rather than generate the objects themselves.

A media content item, or content item, includes audio, video, text, a video game and/or any other media content. A content item may be a single media item. In other examples, it may be a series (or season) of episodes of a content item. Audio includes audio-only content, such as podcasts. Video includes audiovisual content such as movies and/or television programs. Text includes text-only content, such as event descriptions. One example of a suitable media content item is one that complies with the MPEG DASH standard. An OTT, streaming and/or VOD service (or platform) may be accessed via a website and/or an app running on a computing device, and the device may receive any type of content item, including live content items and/or on-demand content items. Content items may, for example, be streamed to physical computing devices. In another example, content items may, for example, be streamed to virtual computing devices in, for example, an augmented environment, a virtual environment and/or the metaverse.

The disclosed methods and systems may be implemented on one or more computing devices. As referred to herein, the computing device can be any device comprising a processor and memory, for example, a television, a smart television, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, a smartwatch, a smart speaker, an augmented reality headset, a mixed reality device, a virtual reality device, a gaming console, or any other television equipment, computing equipment, or wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, random access memory (RAM), etc.

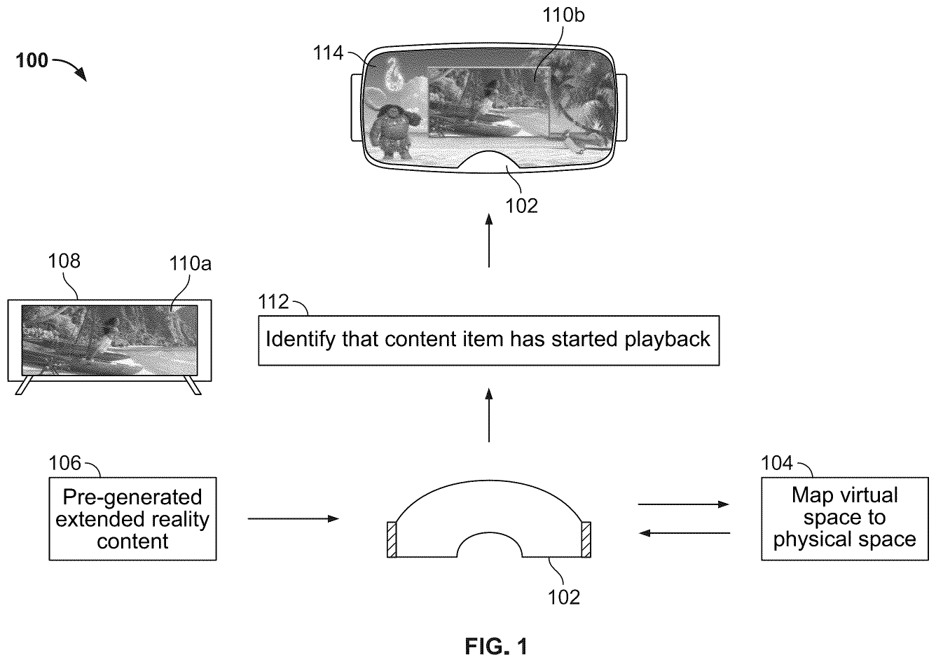

FIG. 1 shows an example environment 100 for enabling an enhanced extended reality experience, in accordance with some embodiments of the disclosure. The environment 100 comprises an extended reality device, such as an augmented reality headset 102, and a computing device, such as a smart television 108. The augmented reality headset 102 spatially maps 104 an extended reality environment, such as an augmented reality environment, based on the physical environment, including smart television 108. In some examples, the augmented reality headset 102 may perform simultaneous localization, mapping, and map optimization of an environment. The augmented reality headset 102 may use built-in sensors to create and manage a spatial map. This may take place at a remote server, for example in the cloud, where the spatial map and point cloud datasets are generated.

At 106, pre-generated extended reality content is received at the augmented reality headset 102. The pre-generated extended reality content may be received from a server via a network, such as the internet. In other examples, the extended reality content may be received from a non-volatile storage device, such as a non-volatile flash memory card, or from a storage device attached to a local network. In some examples, the non-volatile storage device may be distributed with a physical storage medium, such as a Blu-ray disc, for a content item. At the smart television 108, a content item 110a is generated for output. Output of the content item 110a may begin before the pre-generated extended reality content is requested and/or received. In another example, output of the content item 110a may begin after the pre-generated extended reality content is requested and/or received. The content item 110a may be received via any known way, including, for example, over the air, via a cable subscription, via an internet-connected OTT content platform, via any other internet-connected platform and/or application and/or via a physical storage medium, such as a Blu-ray disc. Although this example shows a physical television 108, it is contemplated that the content item could be displayed via the augmented reality headset 102 (or any other extended reality device). At 112, it is identified that the content item 110a has started playback. This identification may be via, for example, data transferred between an application running on the smart television 108 and an application running on the augmented reality headset 102. In other examples, an application running on the extended reality device may use a trained machine learning algorithm to identify that playback has started at the smart television 108. On identifying that the content item has started playback, the augmented reality headset 102 generates the pre-generated extended reality content 114 for output at the augmented reality headset 102. In this example, the augmented reality headset 102 passes through the output from the smart television 108, so a user sees both the content item 110b and the pre-generated extended reality content 114. As the content item progresses, the pre-generated extended reality content 114 may move and/or objects may be added to and/or removed from the virtual scene.

During the creation of a content item, additional 3D extended reality content may be produced, which may relate to the content of the video. For example, creators of an animated movie may additionally create various 3D extended reality environment scenes, objects, animations, and effects that are styled and tinted in the same manner as the content of the movie. A plurality of extended reality objects and scenes may be designed in such a way that they are scalable, tileable, or otherwise suitable for adapting to environments of various shapes and sizes, such as a small room or large room. In the case of virtual reality, an entire virtual space may be created. Metadata indicating the placement possibilities of extended reality objects, such as whether an object, or collection of objects, is for placing on vertical structures such as walls, or are to be presented as free-floating, may be embedded with a content item. In addition, the metadata may comprise timing information used to determine when to display extended reality objects, trigger animations and/or change the objects and/or scenes. The display of these additional extended reality objects, animations and scenes may be enabled or disabled via a user choice or preference accessible via, for example, an OTT platform application. The presence of these additional extended reality objects, animations and scenes may be indicated as being available from within a guide portion of an OTT platform.

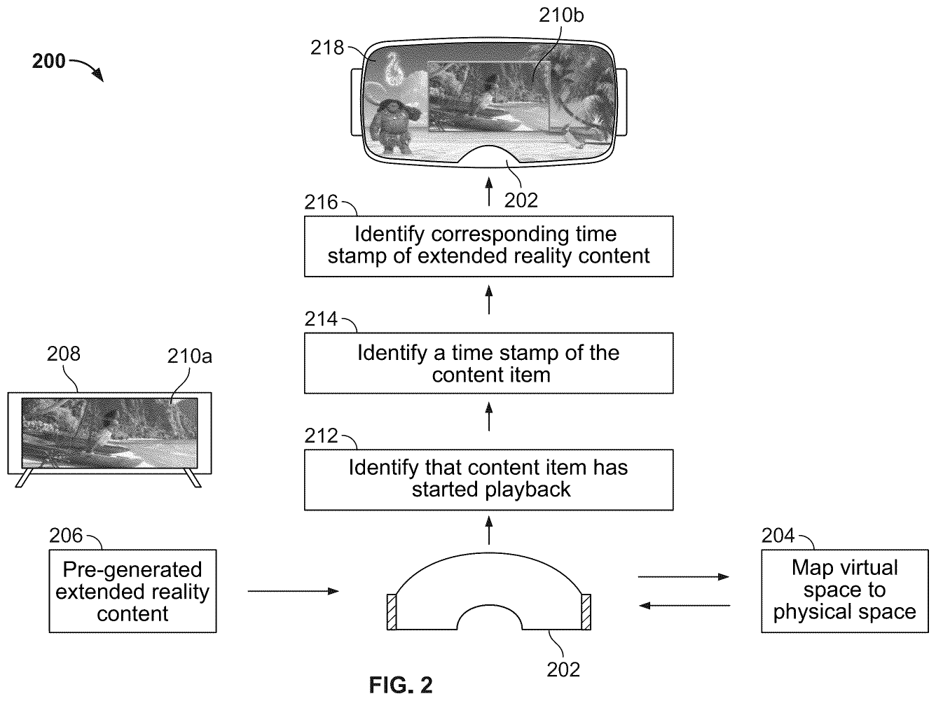

FIG. 2 shows an example environment 200 for enabling an enhanced extended reality experience, in accordance with some embodiments of the disclosure. In a similar manner to the environment shown in FIG. 1, the environment 200 comprises an extended reality device, such as an augmented reality headset 202, and a computing device, such as a smart television 208. The augmented reality headset 202 spatially maps 204 an extended reality environment, such as an augmented reality environment, based on the physical environment, including smart television 208. At 206, pre-generated extended reality content is received at the augmented reality headset 202. At the smart television 208, a content item 210a is generated for output. Output of the content item 210a may begin before the pre-generated extended reality content is requested and/or received. In another example, output of the content item 210a may begin after the pre-generated extended reality content is requested and/or received. Although this example shows a physical television 208, it is contemplated that the content item could be displayed via the augmented reality headset 202 (or any other extended reality device).

At 212, it is identified that the content item 210a has started playback. On identifying that the content item has started playback, a time stamp of the content item may be identified 214. Again, this may be via data transferred between an application running on the smart television 208 and an application running on the augmented reality headset 202. At 216, a corresponding time stamp of the extended reality content is identified. This may be via, for example, metadata associated with the extended reality content. The metadata may indicate one or more pre-generated extended reality objects to generate for display at a particular time stamp. The metadata may also describe paths and/or virtual locations for one or more of the pre-generated extended reality objects that are associated with a time stamp, or time stamps. In other examples, a path of a pre-generated extended reality object may be generated substantially in real time at the augmented reality headset 202. In this manner, the pre-generated extended reality object, or objects, can be synchronized with playback, or output, of the content item 210. The augmented reality headset 202 generates the pre-generated extended reality content 218 for output at the augmented reality headset 202. In this example, the augmented reality headset 202 passes through the output from the smart television 208, so a user sees both the content item 210b and the pre-generated extended reality content 218. As the content item progresses, the pre-generated extended reality content 218 may move and/or objects may be added to and/or removed from the virtual scene.

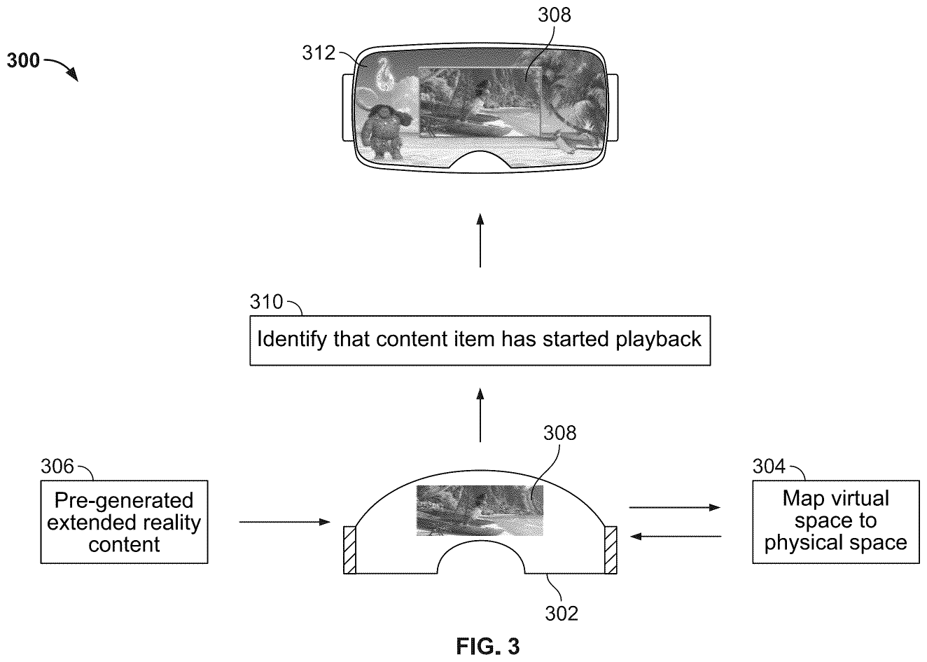

FIG. 3 shows another example environment 300 for enabling an enhanced extended reality experience, in accordance with some embodiments of the disclosure. In a similar manner to the environment shown in FIGS. 1 and 2, the environment 300 comprises an augmented reality headset 302; however, in contrast to the previously described environments, a content item 308 is displayed via the augmented reality headset 302, for example, via a virtual media player. The augmented reality headset 302 spatially maps 304 an extended reality environment, such as an augmented reality environment, based on the physical environment. At 306, pre-generated extended reality content is received at the augmented reality headset 302. At the augmented reality headset 302, a content item 308 is generated for output. Output of the content item 308 may begin before the pre-generated extended reality content is requested and/or received. In another example, output of the content item 308 may begin after the pre-generated extended reality content is requested and/or received.

At 310, it is identified that the content item 308 has started playback. This identification may be via, for example, data transferred between an applications running on the augmented reality headset 302. On identifying that the content item has started playback, the augmented reality headset 302 generates the pre-generated extended reality content 312 for output at the augmented reality headset 302. As the content item progresses, the pre-generated extended reality content 312 may move and/or objects may be added to and/or removed from the virtual scene.

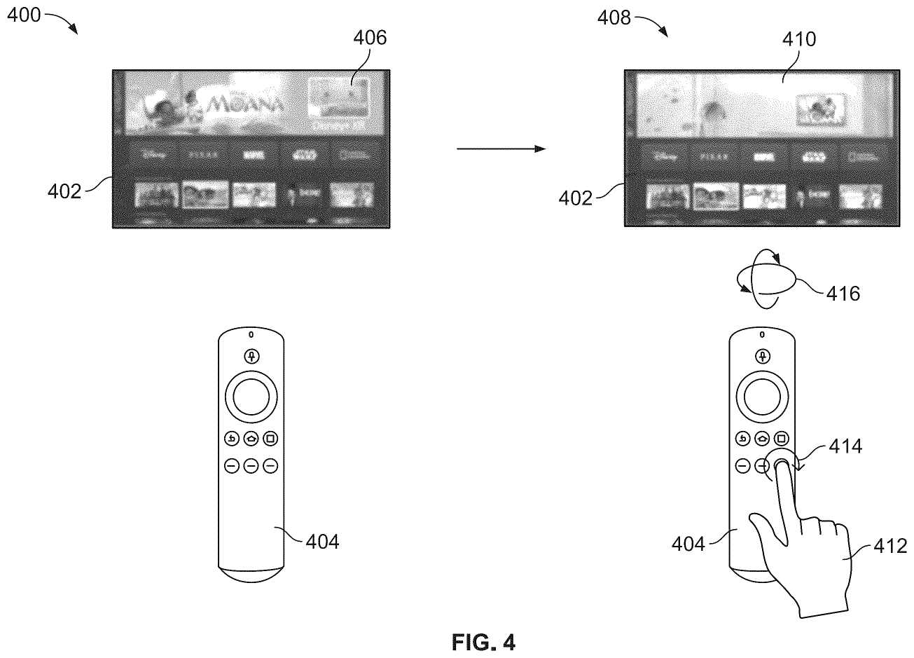

FIG. 4 shows an example environment for enabling a preview of an enhanced extended reality experience, in accordance with some embodiments of the disclosure. The environment 400 comprises a computing device, such as a smart television 402 and an input device, such as remote control 404. The remote control 404 may transmit commands for controlling the smart television 402 via, for example, infrared, Bluetooth and/or Wi-Fi. The smart television generates a media guidance application of, for example, an OTT platform for display. The media guidance application comprises an indication 406 that pre-generated extended reality content is available for a particular content item. The indication may comprise an icon; a picture associated with the content item; a frame, or a plurality of frames, from the content item; and/or text associated with the content item and/or the pre-generated extended reality content.

On receiving input associated with the indication 406, a preview of the pre-generated extended reality content may be made available, as shown in environment 408. In this example, a 2D representation 410 of the pre-generated extended reality content is generated for output at the smart television. In other examples, a preview may be generated for output at an extended reality device (not shown) that is associated with the smart television and/or OTT platform. The preview may be utilized to encourage a user to purchase pre-generated extended reality content in addition to a content item. In this example, a user may navigate the preview of the pre-generated extended reality content via the remote control 404. The remote control may receive input via a hand 412 of a user. This may comprise a user selecting a button on the remote control in order to move through the preview of the pre-generated augmented reality content in a particular direction, for example, via arrow buttons on the remote control 404. In another example, the remote control 404 may receive directional user input 414 via, for example, a touch pad on the remote control 404. In a further example, the user may use the remote control 404 itself to navigate the preview of the pre-generated extended reality content. For example, the user may move the remote control 404 about X and Y axes, and motion input 416 may be transmitted from the remote control 404 to the smart television 402. The motion input 416 may be detected via an inertial measurement unit integral to the remote control 404.

The display of the preview may be shown within the guide of an OTT application using a pre-defined “3D room,” or with a 3D representation of a spatially mapped representation of the user's actual room if one exists and is associated with the logical “room” group of the media streaming device or eco-system. This may occur if the user has previously spatially scanned their room and has associated the mapping of their room with the OTT platform, for example, via a user profile used to log on to the OTT platform.

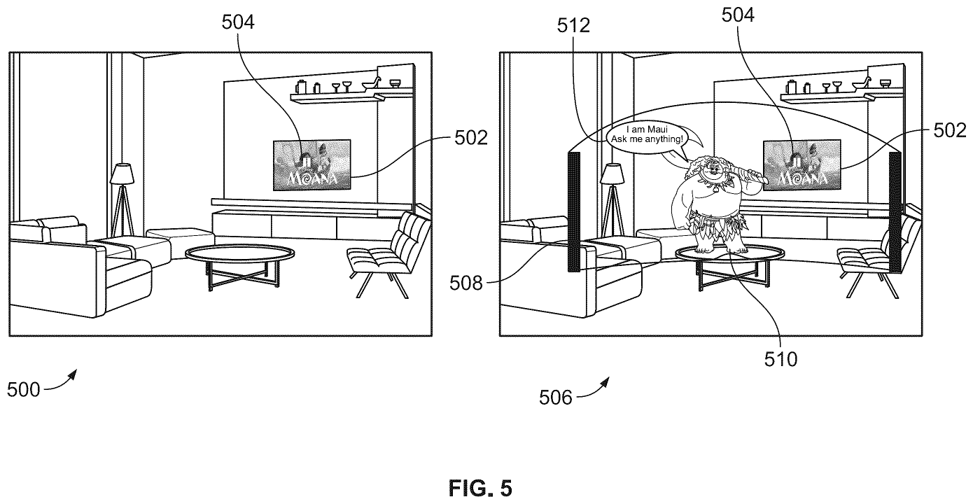

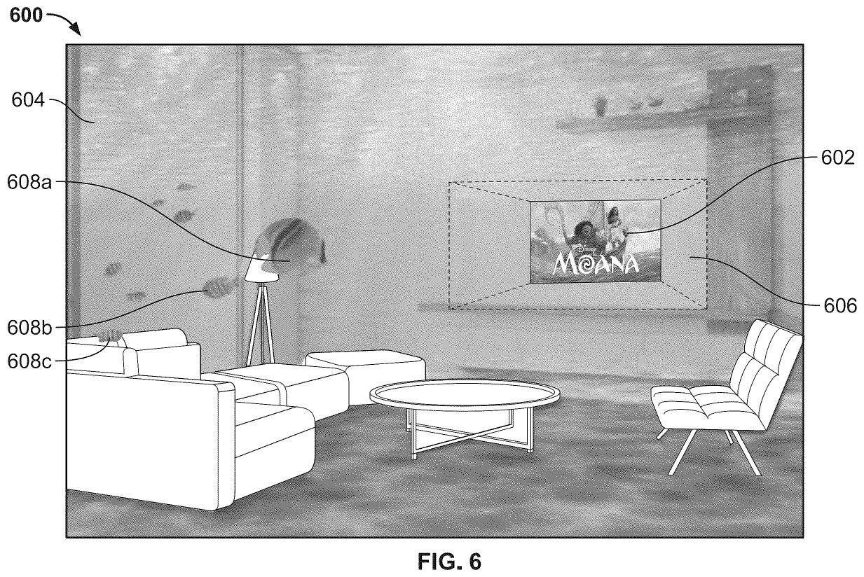

FIG. 5 shows a first example environment 500, and a second example environment 506. The first example environment 500 shows an environment without an extended reality device. The second example environment 506 shows an environment with an extended reality device, for enabling an extended reality avatar, in accordance with some embodiments of the disclosure. The environment 500 comprises a smart television 502. The smart television 502 generates a content item for output that is currently paused 504. Environment 506 shows the same room depicted in environment 500, but through an extended reality device, such as augmented reality headset 508. The smart television 502 and paused 504 content item can be seen, but in addition an extended reality avatar 510 is generated for output at the augmented reality headset 508. A user can interact with the extended reality avatar 510 via, for example, voice commands. In this example, the extended reality avatar 510 displays a prompt, in this case, “I am Maui. Ask me anything!” On receiving a query, an application associated with the avatar may transmit the query to, for example, a server via the internet. A response to the query may be transmitted back to the augmented reality device 508 and generated for output. On resumption of playback of the content item, the avatar may disappear. In some examples, the avatar may be a character and/or object from the content item being played on the smart television 502. In other examples, the avatar may be a generic avatar associated with a query service, such as Amazon Alexa. In further examples, the avatar may be associated with a product and may be limited to answering queries related to a product.

Potential interactions with extended reality objects, such as via voice or with a controller, may be described in the metadata and incorporated into pre-generated extended reality content. For example, metadata may describe potential interactions with a 3D representation of an animated character from a movie. The metadata may indicate that the, for example, character can be interacted with via an extended reality controller. For example the character may be interacted with via button pushes on the controller, with a plugin for a smart home assistant to allow audio input and control, or with a microphone incorporated into the controller that allows users to ask questions. The extended reality controller may enable a user to control a generated extended reality character and/or an object while the content item is paused. A response or query received from a user may cause a new content item to be played or resumption of playback of the original content item. Playback of a content item may be paused when a microphone button is pushed on the controller and resumed when the microphone button is depressed. In another example, playback of a paused content item may resume when audio input has stopped for a threshold amount of time.

FIG. 6 shows an example 600 for enabling a “keep-out” area in an extended reality experience, in accordance with some embodiments of the disclosure. In a similar manner to the environments shown in FIGS. 1-5, the environment 600 represents a view as seen through an extended reality device (not shown). The environment comprises a display, such as the display of a smart television 602, showing a content item and a pre-generated extended reality environment 604. A “keep-out” area, or volume, 606 surrounds the display of the smart television 602. Pre-generated virtual reality objects 608a, 608b, 608c are programmed such that their paths do not enter the area, or volume, around the display. This enables, for example, a content item to be viewed without the virtual reality objects 608a, 608b, 608c obscuring the view. In some examples, the size of the “keep-out” area, or volume, 606 may change based on, for example, a distance of the extended reality device from the display of the smart television 602. In another example, the shape of the “keep-out” area may change based on a relative position of the extended reality device. For example, the “keep-out” area, or volume, 606 may have a first shape if the extended reality device is substantially in front of the display of the smart television 602, and a second shape if the extended reality device is to one side of the display of the smart television 602. In another example, the perspective of the “keep-out” area, or volume, 606 may change based on the relative position of the extended reality device.

In some examples, synchronized playback of a plurality of displays may be enabled. The plurality of displays may include any extended reality, including augmented and/or virtual reality headsets. The synchronized playback may be triggered, or queued directly, via the selection of an icon, or button, within a media guide of, for example, an OTT application running on an extended reality headset. The extended reality headsets may be logically grouped within a logical “room” grouping, via selection from the application running on the extended reality headsets. During interaction with, for example, an object or character, such as when the user pauses the media content, the display of an extended reality headset may be rendered on both the synchronized headset and a non-extended reality display, thereby enabling the viewer of the non-extended reality display to experience, or view, what the synchronized extended reality viewer is experiencing. During synchronized playback, an extended reality headset may mirror its display on a secondary screen (for example, a smart television) in order to share the extended reality experience with a synchronized non-extended reality-enabled viewer.

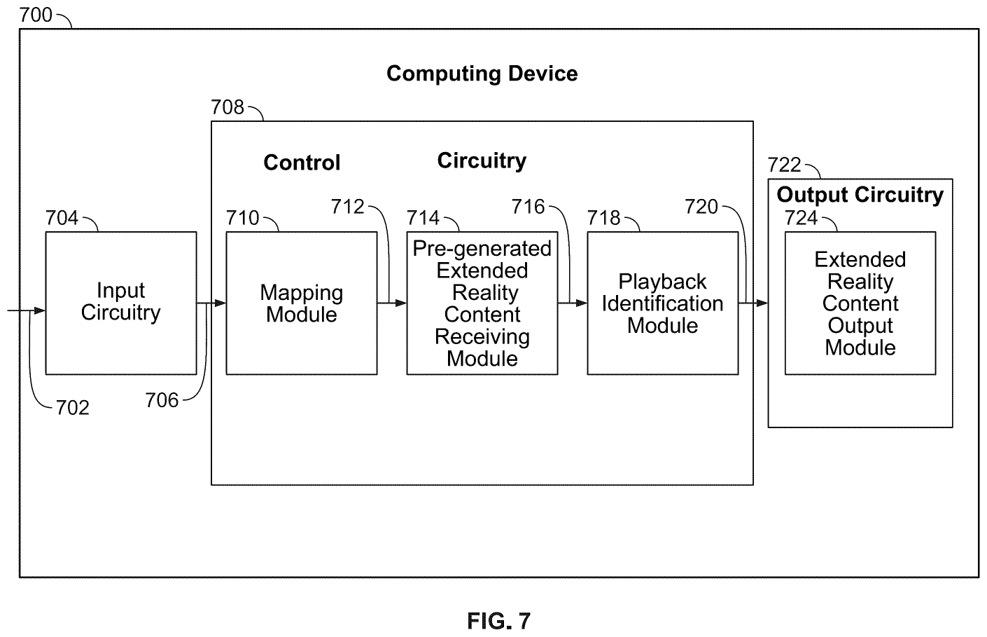

FIG. 7 shows a block diagram representing components of an example computing device 700, such as an extended reality device, and dataflow therebetween for enabling an enhanced extended reality experience, in accordance with some embodiments of the disclosure. Computing device 700 (e.g., extended reality devices 102, 108, 202, 208, 302, 308, 402, 502, 508, 602) comprises input circuitry 704, control circuitry 708 and output circuitry 722. Control circuitry 708 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

Input is received 702 by the input circuitry 704. The input circuitry 702 is configured to received inputs related to a computing device. For example, this may be via gesture detected via an extended reality device. In other examples, this may be via an infrared controller, Bluetooth and/or Wi-Fi controller of the computing device 700, a touchscreen, a keyboard, a mouse and/or a microphone. In another example, the input may comprise instructions received via another computing device. The input circuitry 704 transmits 706 the user input to the control circuitry 708.

The control circuitry 708 comprises a mapping module 710, a pre-generated extended reality content receiving module 714, and a playback identification module 718. The output circuitry 722 comprises an extended reality content output module 724. The input is transmitted 706 to the mapping module 710, where a virtual space is mapped to a physical space. On mapping the virtual space to the physical space, an indication is transmitted 712 to the pre-generated extended reality content receiving module 714. On receiving the pre-generated extended reality content at the module 714, an indication is transmitted 716 to the playback identification module 718. On identifying that playback of the content item has started, an indication is transmitted 720 to the output circuitry 722, where the pre-generated extended reality content is generated for output at the extended reality content output module 724.

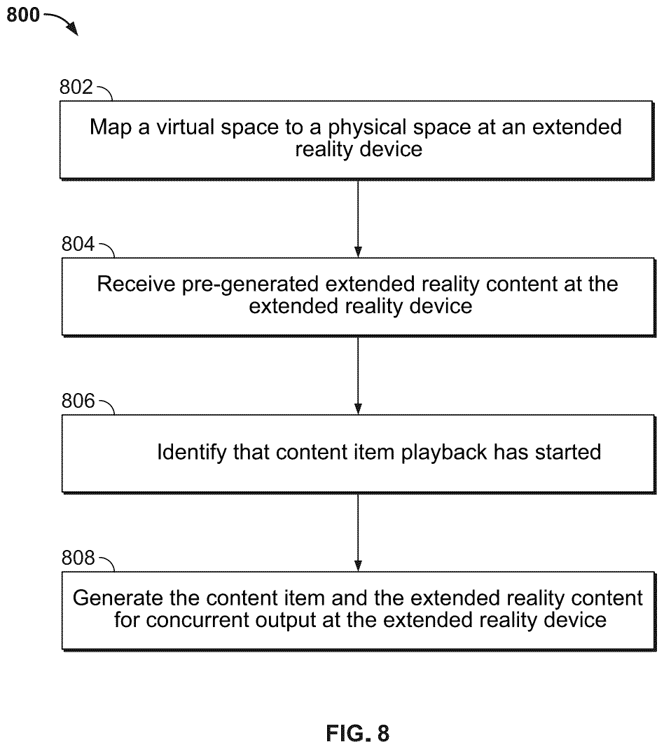

FIG. 8 shows a flowchart of an example process 800 including illustrative steps involved in enabling an enhanced extended reality experience, in accordance with some embodiments of the disclosure. Process 800 may be implemented, in whole or in part, on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 800 may be incorporated into or combined with one or more actions of any other process or embodiments described herein.

At 802, a virtual space is mapped to a physical space at an extended reality device. The extended reality device may spatially map an extended reality environment, such as an augmented reality environment, based on the physical environment. In some examples, the extended reality device may perform simultaneous localization, mapping, and map optimization of an environment. The extended reality device may use built-in sensors to create and manage a spatial map. This may take place at a remote server, for example in the cloud, where the spatial map and point cloud datasets are generated. At 804, pre-generated extended reality content is received at the extended reality device. The pre-generated extended reality content may be received from a server via a network, such as the internet. In other examples, the extended reality content may be received from non-volatile storage device, such as a non-volatile flash memory card, or from a storage device attached to a local network. In some examples, the non-volatile storage device may be distributed with a physical storage medium, such as a Blu-ray disc, for a content item.

At 806, it is identified whether content item playback has started. Playback of a content item may be at a physical computing device, such as a smart television and/or via the extended reality device itself. This identification may be via, for example, data transferred between an application running on a smart television and an application running on the extended reality device. In other examples, an application running on the extended reality device may use a trained machine learning algorithm to identify that playback has started at the smart television. In further examples, multiple applications running on the extended reality device may communicate to indicate that playback has started. At 808, the content item and the extended reality content are generated for concurrent output at the extended reality device and/or other computing device, such as a smart television.

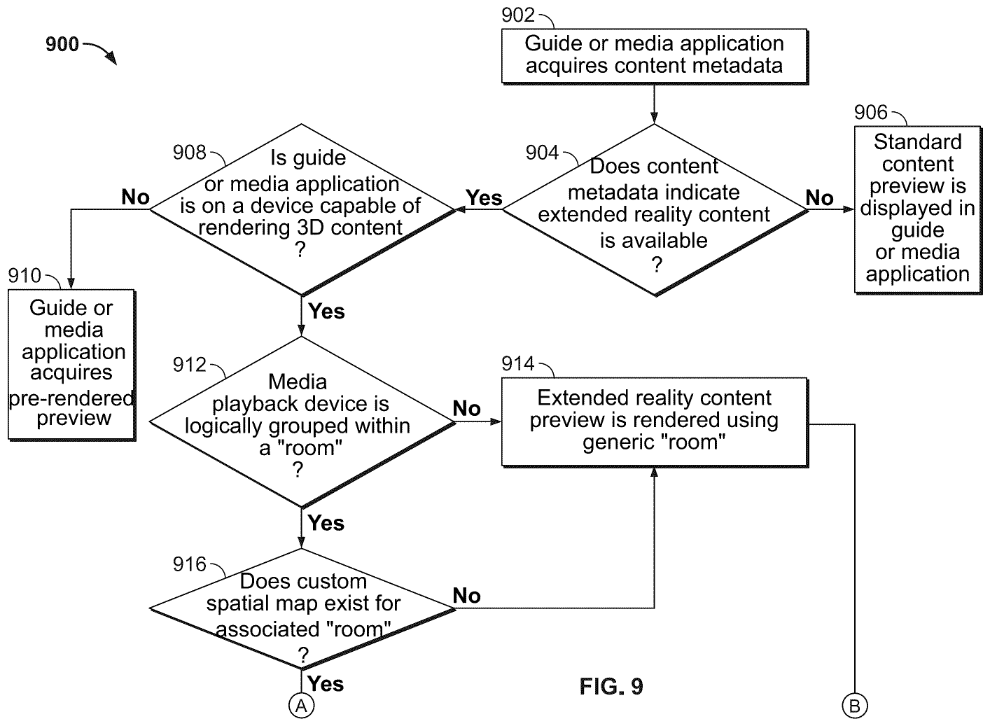

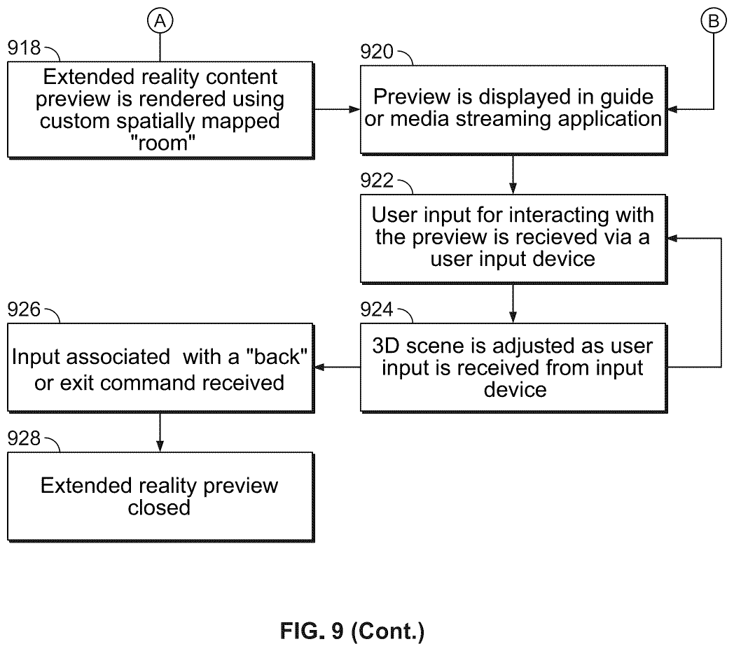

FIG. 9 shows a flowchart of an example process 900 including illustrative steps involved in enabling extended reality content to be previewed within a guide or media application, in accordance with some embodiments of the disclosure. Process 900 may be implemented, in whole or in part, on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 900 may be incorporated into or combined with one or more actions of any other process or embodiments described herein.

At 902, a guide or media application acquires content metadata. At 904, it is determined whether the content metadata indicates that extended reality content is available. If it is determined that extended reality content is not available, at 906, a standard content preview is displayed in the guide or media application. If it is determined that extended reality content is available, then the process proceeds to step 908, where it is determined whether the guide or media application is on a device that is capable of rendering 3D content. If it is determined that the device is not capable of rendering 3D content, then, at 910, the guide or media application acquires a pre-rendered preview, for example, from a server accessible via a network such as the internet. If it is determined, at 908, that the device is capable of rendering 3D content then the process proceeds to step 912, where it is determined whether the media playback device is logically grouped within a “room,” or any other logical, or virtual, grouping of devices that may have a visual rendering associated with it.

If, at 912, it is determined that the device is not grouped within a “room,” then, at 914, an extended reality content preview is rendered using a generic “room,” and the process proceeds to step 920, which is discussed below. If, at 912, it is determined that the device is grouped within a “room,” then, at 916, it is determined whether a custom spatial map exists for the associated “room.” If a spatial map does not exist, then the process proceeds to step 914, which is discussed above. If a spatial map does exist, then the process proceeds to step 918, where an extended reality content preview is rendered using a custom spatially mapped “room.” At 920, the preview is displayed in a guide or media streaming application. At 922, user input for interacting with the preview is received via a user input device. At 924, the 3D scene is adjusted as user input is received from the user input device. The process loops back to step 922 as additional user input, or inputs, is received. At 926, input associated with a “back,” or exit, command is received, and at 928 the extended reality preview is closed.

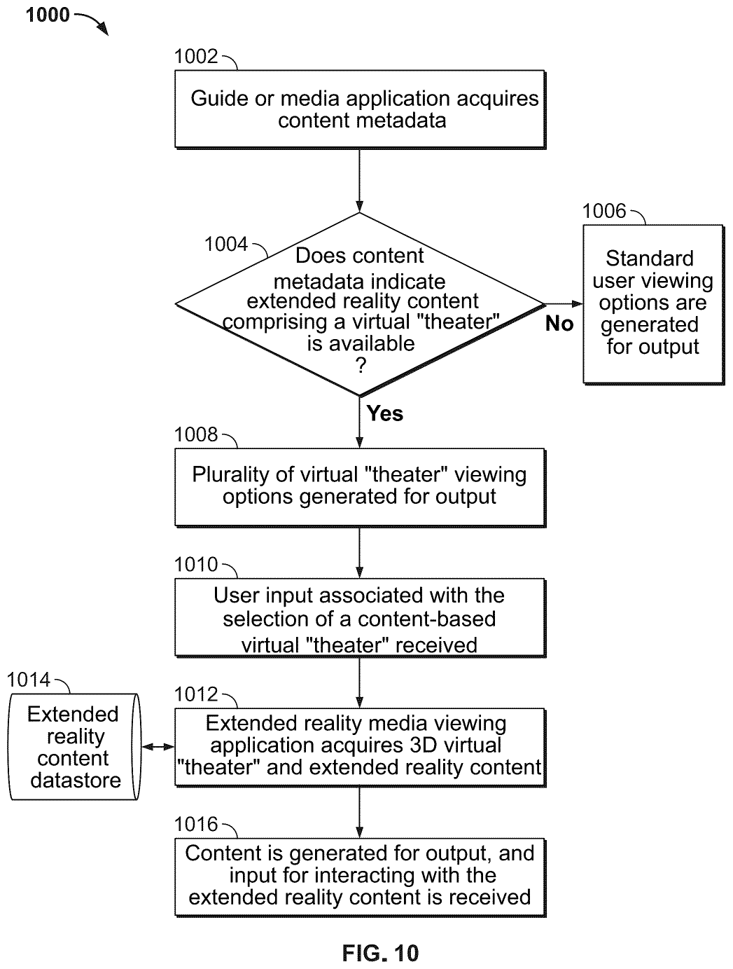

FIG. 10 shows a flowchart of an example process 1000 including illustrative steps involved in enabling a content-based virtual “theater” environment and changing the virtual reality environment to a virtual “theater,” in accordance with some embodiments of the disclosure. Process 1000 may be implemented on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 1000 may be incorporated into or combined with one or more actions of any other process or embodiments described herein.

At 1002, a guide or media application acquires content metadata. At 1004, it is determined whether the content metadata indicated that extended reality content comprising a virtual “theater” is available. If a virtual “theater” is not available, then, at 1006, standard viewing options are generated for output. If one or more virtual “theaters” are available, then, at 1008, a plurality of virtual “theater” viewing options are generated for output. At 1010, user input associated with the selection of a content-based virtual “theater” is received. At 1012, an extended reality media viewing application acquires a 3D virtual “theater” and associated extended reality content from an extended reality content datastore 1014 via, for example, a network such as the internet. The process proceeds to 1016, where content is generated for output, and input for interacting with the extended reality content is received.

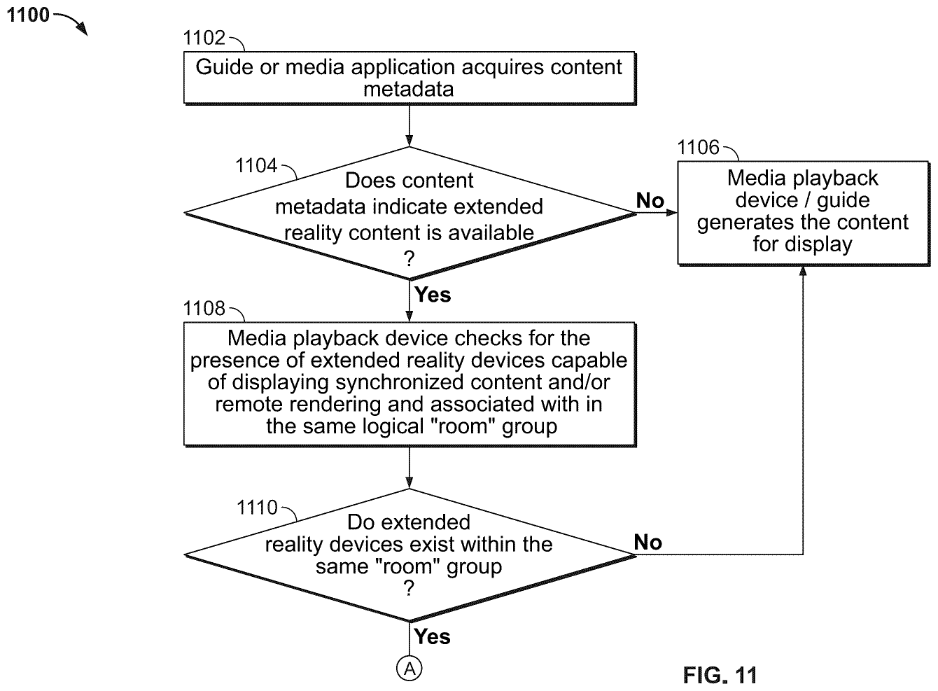

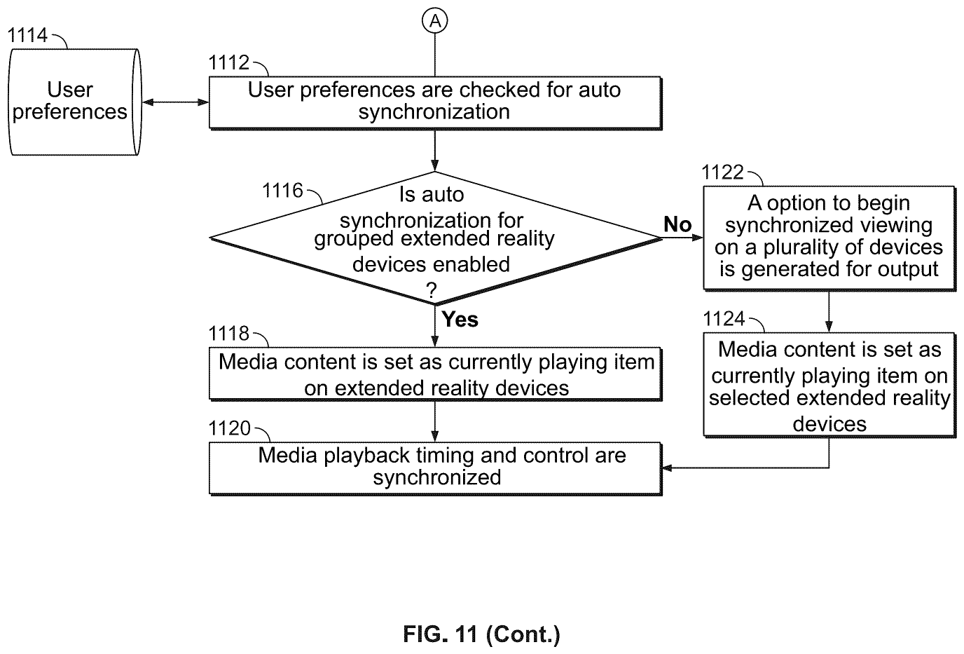

FIG. 11 shows a flowchart of an example process 1100 including illustrative steps involved in enabling the playback of media content in a synchronized manner, in accordance with some embodiments of the disclosure. Process 1100 may be implemented on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 1100 may be incorporated into or combined with one or more actions of any other process or embodiments described herein.

At 1102, a guide or media application acquires content metadata. At 1104, it is determined whether the content metadata indicates that extended reality content is available. If extended reality content is not available, then, at 1106, the media playback device, or guide, generates the content for display. If, at 1104, the content metadata indicates that extended reality content is available, then at 1108, the media playback device checks for the presence of extended reality devices that are capable of displaying synchronized content and/or are capable of remote rendering, and are associated within the same logical “room” group. At 1110, it is determined whether the extended reality devices exist within the same “room” group. If it is determined that the extended reality devices do not exist within the same “room” group, then the process proceeds to step 1106. If it determined that the extended reality devices do exist within the same “room” group, then the process proceeds to step 1112. At 1112, one or more user preferences are accessed via database 1114, which may be a local database and/or a remote database that is available via a network, such as the internet. The preferences are checked to see if an auto synchronization preference has been selected. The process proceeds to 1116, where it is determined whether auto synchronization for the grouped extended reality devices is enabled. If it is determined that the auto synchronization is enabled for the grouped extended reality devices, then the process proceeds to step 1118, where the media content is set as the currently playing item on the extended reality devices. At 1120, the media playback, or output, timing and control are synchronized. If, at 1116, it is determined that auto synchronization for the grouped extended reality devices is not enabled, then the process proceeds to step 1122. At 1122, an option to begin synchronized viewing on a plurality of devices is generated for output, for example, an option may be generated for output on all, or a subset, of the plurality of devices. At 1124, the media content is set as the currently playing item on the selected extended reality devices, and the process proceeds to step 1120.

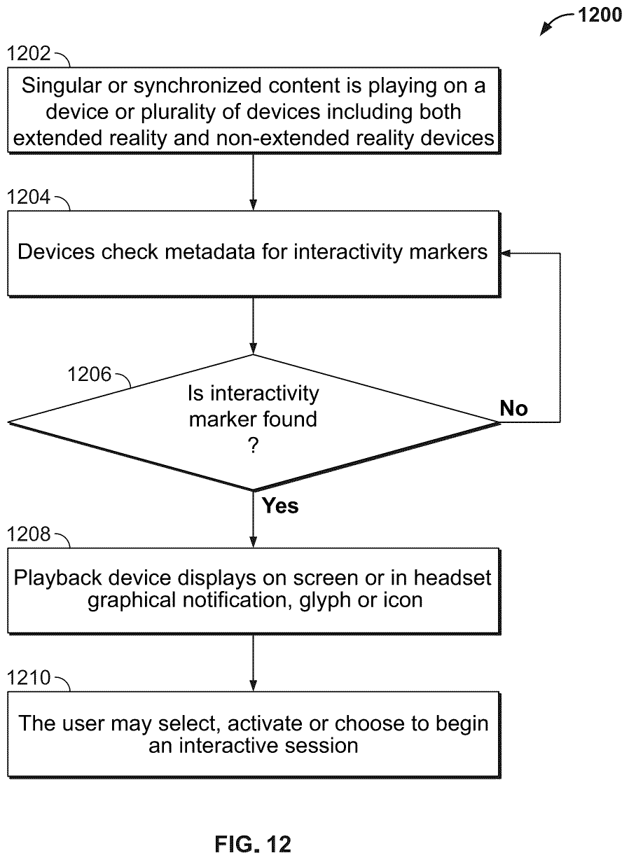

FIG. 12 shows a flowchart of an example process 1200 including illustrative steps involved in enabling an interactive extended reality experience, in accordance with some embodiments of the disclosure. Process 1200 may be implemented on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 1200 may be incorporated into or combined with one or more actions of any other process or embodiments described herein.

At 1202, singular or synchronized content is playing, or being generated for output, on a device, or a plurality of devices, including both extended reality and non-extended reality devices. At 1204, one or more of the devices check metadata associated with the content for one or more interactivity markers. At 1206, it is determined whether an interactivity marker is found. If it is determined that an interactivity marker has not been found, then the process loops back to step 1204. If it is determined than an interactivity marker has been found, then the process proceeds to step 1208. At 1208, the playback device displays, or generates for output, on a screen, or in a headset, a graphical notification, glyph and/or icon. At 1210, the user may select, activate and/or choose to begin an interactive session. In some examples, this may be via the graphical notification, glyph and/or icon.

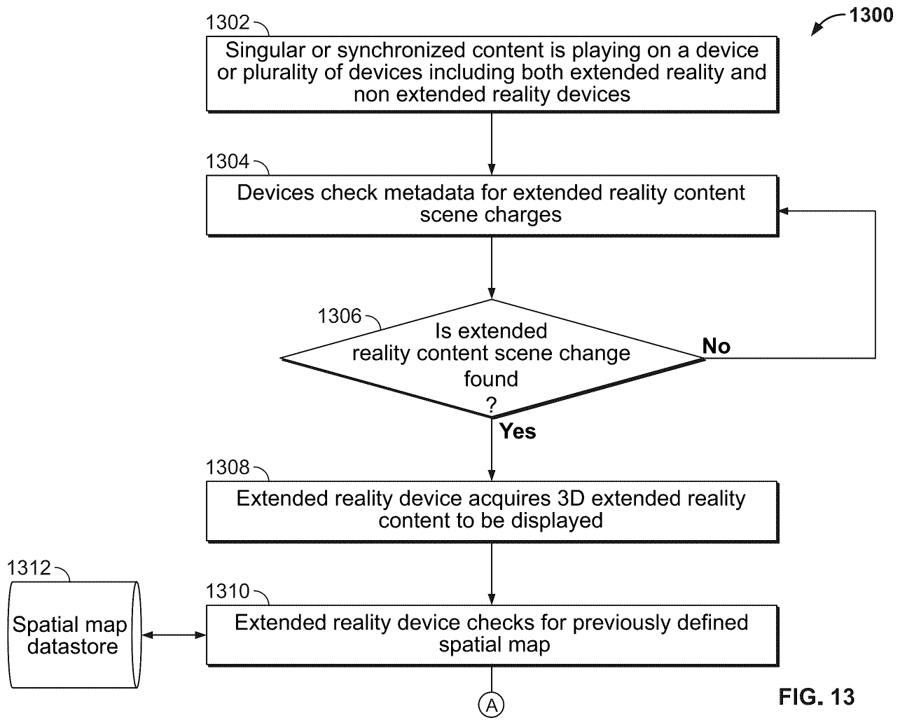

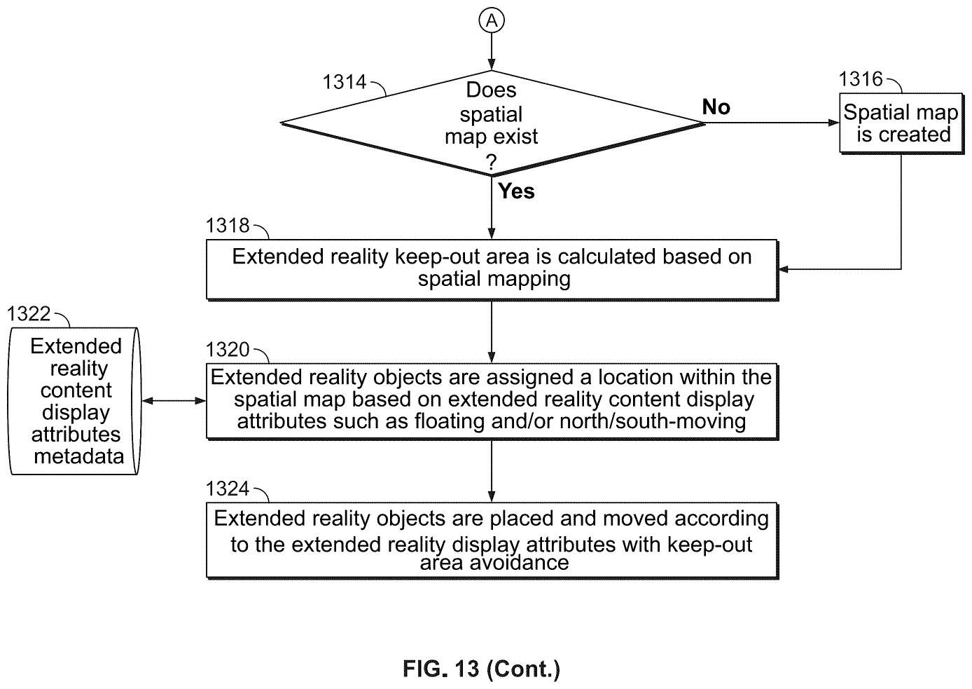

FIG. 13 shows a flowchart of an example process 1300 including illustrative steps involved in enabling the generation of extended reality content for display in a spatially mapped room, in accordance with some embodiments of the disclosure. Process 1300 may be implemented on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 1300 may be incorporated into or combined with one or more actions of any other process or embodiments described herein.

At 1302, singular (i.e., unsynchronized) content or synchronized content is playing, or being generated for playback, on a device, or a plurality of devices, including both extended reality and non-extended reality devices. At 1304, the device, or plurality of devices, checks metadata associated with the content for extended reality content scene changes. At 1306, it is determined whether an extended reality content scene change is found in the metadata. If it is determined that no scene change has been found, the process loops back to step 1304. If it is determined that a scene change has been found, the process proceeds to step 1308, where the extended reality device acquires 3D extended reality content to be displayed. At 1310, the extended reality device checks a spatial map datastore 1312 for a previously defined spatial map. The spatial map datastore 1312 may be integral, or local, to the extended reality device. In other examples, the extended reality device may alternatively, or additionally, check the spatial map datastore 1312 via a network such as the internet. The process proceeds to step 1314, where it is determined whether a spatial map exists. If it is determined that a spatial map does not exist, then the process proceeds to step 1316, where a spatial map is created.

If it is determined that a spatial map exists, then the process proceeds to step 1318, where an extended reality “keep-out” area is calculated based on the spatial mapping. In some examples, the “keep-out” area may be an area, or volume, in front of, or around a device for generating content for output. Such a device may be a smart television. The “keep-out” area may be defined according to 2D dimensions or 3D dimensions. The “keep-out” area may be calculated based on dimensions of the display, a distance between the display and the user, a 3D position or orientation of the user's head in space, user preferences indicating how much “clear space” a user wants to maintain around the display while watching, etc. Pre-generated extended reality elements, or objects, follow paths, for example, that prevent them from entering the “keep-out” area, or volume. At 1320 extended reality objects are assigned a location within the spatial map based on extended reality content display attributes, such as “floating,” and/or directional attributes, such as moving in a relative “north” or “south” direction. The extended reality content display attributes may be accessed via extended reality content display attributes metadata 1322. The extended reality content display attributes metadata 1322 may be integral, or local, to the extended reality device. In other examples, the extended reality device may alternatively, or additionally, access the extended reality content display attributes metadata 1322 via a network such as the internet. At 1324, the extended reality objects are placed and moved according to the extended reality display attributes with “keep-out” area avoidance, as discussed above.

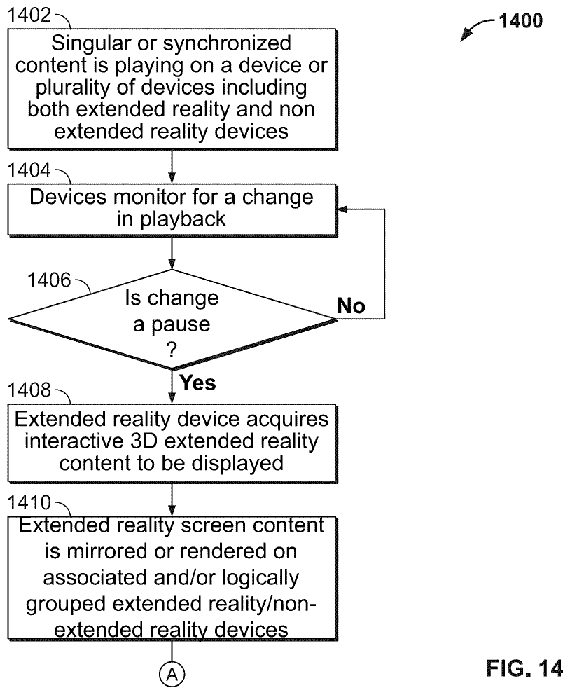

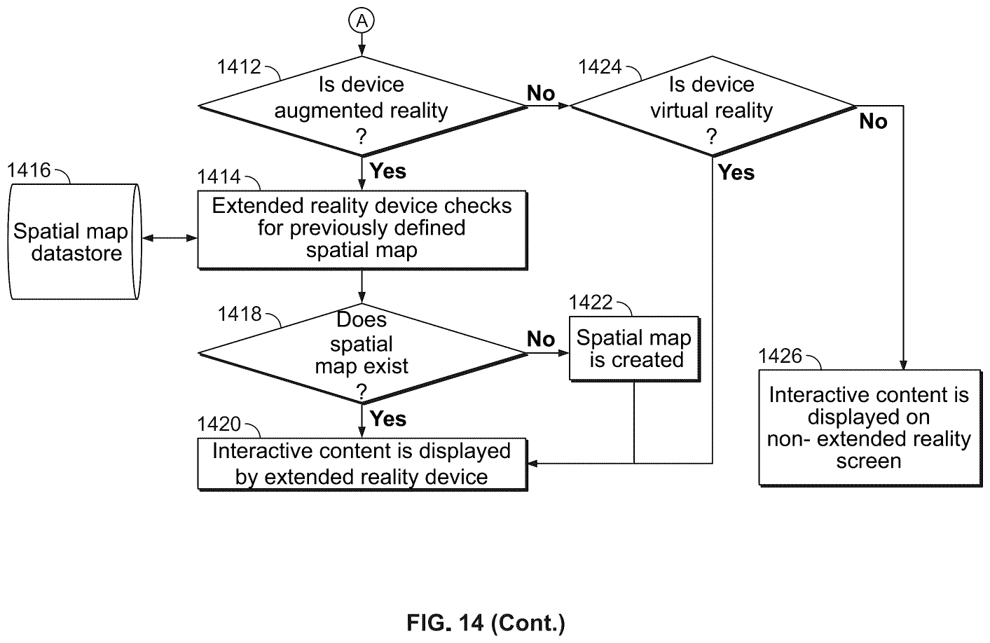

FIG. 14 shows a flowchart of an example process 1400 including illustrative steps involved in enabling interactive extended reality content to be generated for display in response to a pause command, in accordance with some embodiments of the disclosure. Process 1400 may be implemented on any of the aforementioned computing devices (e.g., computing devices 102, 108, 202, 208, 302, 308, 402, 502, 508, 602; e.g., by way of executing one or more instructions or routines stored to memory or storage of a device). In addition, one or more actions of the process 1400 may be incorporated into or combined with one or more actions of any other process or embodiments described herein.

At 1402, singular or synchronized content is playing, or being generated for output, at a device, or a plurality of devices, including both extended and non-extended reality devices. At 1404, the extended and/or non-extended reality devices monitor for a change in playback, or generation for output, status. At 1406, it is determined whether the change in status is a pause status. If it is determined that the change in status is not a pause, then the process loops back to step 1404. If it is determined that the change in status is a pause, then the process proceeds to step 1408. At 1408, the extended reality device acquires interactive 3D extended reality content to be displayed, or generated for output. At 1410, the extended reality screen content, or output, is mirrored or rendered on an associated and/or logically grouped extended reality and/or non-extended reality device. At 1412, it is determined whether the extended reality device is an augmented reality device, such as an augmented reality headset.

If, at 1412, it is determined that the extended reality device is an augmented reality headset, then the process proceeds to step 1414, where the extended reality device checks for a previously defined spatial map via a spatial map datastore 1416. The datastore 1416 may be integral, or local, to the extended reality device. In other examples, the extended reality device may alternatively, or additionally, access the spatial map datastore 1416 via a network such as the internet. At 1418, it is determined whether a spatial map exists. If it is determined that a spatial map exists, then, at 1420, interactive content is displayed, or generated for output, at the extended reality device, for example, on the screen of an extended reality device. If, at 1418, it is determined that a spatial map does not exist, then, at 1422, a spatial map is created and the process proceeds to step 1420.

If, at 1412, it is determined that the extended reality device is not an augmented reality device, then the process proceeds to 1424, where it is determined whether the device is a virtual reality device. If it is determined that the device is a virtual reality device, the process proceeds to step 1420. If it is determined that the device is not a virtual reality device, then the process proceeds to step 1426, where the interactive content is displayed, or generated for display, via a non-extended reality device.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
mapping, at an extended reality device, a virtual space to a physical space;
receiving, at the extended reality device, pre-generated extended reality content for display with a content item;
identifying that the content item has started playback at a display; and
generating, for concurrent output at the extended reality device, the content item and the extended reality content.

2. The method of claim 1, further comprising:
identifying a time stamp of the content item;
identifying a corresponding time stamp of the extended reality content; and
wherein generating the extended reality content for output at the extended reality device further comprises generating the extended reality content for output at the corresponding time stamp.

3. The method of claim 1, wherein the display is a physical display, the method further comprising:
identifying, at the extended reality device, the physical display; and
playing back the content item at the physical display.

4. The method of claim 1, wherein the display is a virtual display, the method further comprising:
generating, at the extended reality device, a virtual display for outputting the content item; and
playing back the content item at the virtual display.

5. The method of claim 1, wherein the pre-generated extended reality content further comprises metadata indicating a relative location, movement data and/or timing data for an extended reality object, animation and/or scene.

6. The method of claim 1, further comprising:
receiving, at a physical computing device, a request to access a preview of the pre-generated extended reality content;
generating, for output at the physical computing device, a two-dimensional representation of at least a portion of the virtual reality content;
receiving, at the physical computing device, input associated with navigating the preview; and
generating for output, at the physical computing device and based on the input, an updated view of the virtual reality content.

7. The method of claim 1, further comprising:
receiving user input to pause the content item;
pausing playback of the content item; and
generating, for output at the extended reality device, a pre-generated virtual reality object for display while the content item is paused.

8. The method of claim 6, further comprising:
integrating a virtual assistant with the virtual reality object;
receiving a query via the integrated virtual assistant;
generating a response to the query; and
concurrently outputting the response to the query and animating the virtual reality object based on the response to the query.

9. The method of claim 1, further comprising:
identifying, in the virtual space, a volume around the display;
identifying a path of one or more extended reality objects in the extended reality content;
for each identified path, determining whether the path will intersect with the volume, and
for each path that intersects with the volume, amending the path so that it does not intersect with the volume.

10. The method of claim 2, wherein the extended reality device is a first extended reality device, the method further comprising:
receiving, at a second extended reality device, the pre-generated extended reality content for display with the content item;
generating, for output at the second extended reality device, the extended reality content at the corresponding time stamp;
identifying a user interaction with an extended reality object at the first extended reality device; and
generating, for output at the first and second extended reality devices and based on the user interaction, the extended reality object.

11. The method of claim 1, further comprising:
generating, for output, a content item guidance application, wherein the content item guidance application comprises:
a selectable asset region corresponding to a content item; and
an icon, associated with the asset region, wherein the icon indicates that extended reality content is available for the content item.

12. A system comprising:
control circuitry configured to:
map, at an extended reality device, a virtual space to a physical space;
input circuitry configured to:
receive, at the extended reality device, pre-generated extended reality content for display with a content item;
the control circuitry further configured to:
identify that the content item has started playback at a display; and
generate, for concurrent output at the extended reality device, the content item and the extended reality content.

13. The system of claim 12, wherein:
the control circuitry is further configured to:
identify a time stamp of the content item;
identify a corresponding time stamp of the extended reality content; and
wherein the control circuitry is configured to generate the extended reality content for output at the extended reality device by generating the extended reality content for output at the corresponding time stamp.

14. The system of claim 12, wherein the display is a physical display, and the control circuitry is further configured to:
identify, at the extended reality device, the physical display; and
play back the content item at the physical display.

15. The system of claim 12, wherein the display is a virtual display, and the control circuitry is further configured to:
generate, at the extended reality device, a virtual display for outputting the content item; and
play back the content item at the virtual display.

16. The system of claim 12, wherein the pre-generated extended reality content further comprises metadata indicating a relative location, movement data and/or timing data for an extended reality object, animation and/or scene.

17. The system of claim 12, wherein the control circuitry is further configured to:
receive, at a physical computing device, a request to access a preview of the pre-generated extended reality content;
generate, for output at the physical computing device, a two-dimensional representation of at least a portion of the virtual reality content;
receive, at the physical computing device, input associated with navigating the preview; and
generate for output, at the physical computing device and based on the input, an updated view of the virtual reality content.

18. The system of claim 12, wherein:
the input circuitry is further configured to:
receive user input to pause the content item; and
the control circuitry is further configured to, in response to receiving the user input:
pause playback of the content item; and
generate, for output at the extended reality device, a pre-generated virtual reality object for display while the content item is paused.

19. The system of claim 18, wherein the control circuitry is further configured to:
integrate a virtual assistant with the virtual reality object;
receive a query via the integrated virtual assistant;
generate a response to the query; and
concurrently output the response to the query and animate the virtual reality object based on the response to the query.

20. The system of claim 12, wherein the control circuitry is further configured to:
identify, in the virtual space, a volume around the display;
identify a path of one or more extended reality objects in the extended reality content;
for each identified path, determine whether the path will intersect with the volume, and
for each path that intersects with the volume, amend the path so that it does not intersect with the volume.

21-55. (canceled)
